(19) United States
(12) Patent Application Publication
(10) Pub. No.: US 2015/0191957 A1
(43) Pub. Date: Jul. 9, 2015

(54) GUIDE PULLY SUPPORT STRUCTURE OF WINDOW REGULATOR

(71) Applicant: SHIROKI CORPORATION, Kanagawa (JP)

(72) Inventors: Norihide Takeda, Kanagawa (JP); Kimihiro Kinoshita, Kanagawa (JP)

(73) Assignee: SHIROKI CORPORATION, Kanagawa (JP)

(21) Appl. No.: 14/414,005

(22) PCT Filed: Jul. 8, 2013
(86) PCT No.: PCT/JP2013/068616

§ 371 Date: Jan. 9, 2015

(30) Foreign Application Priority Data
Dec. 7, 2012 (JP) 2012-156260

(51) Int. Cl. E05F 11/48

(52) U.S. Cl. CPC E05F 11/483; E05Y 2201/668

(57) ABSTRACT

In a guide pulley support structure of a window regulator in which a guide pulley is supported by a holed shaft member and a guide pulley supporting member, a guide pulley support structure is obtained which makes it possible to firmly couple together the guide pulley supporting member and the holed shaft member. A groove is formed on an end surface of the holed shaft member, wherein the holed shaft member and the guide pulley supporting member are coupled together by inserting a connecting edge, which is formed by plastically deforming an inner peripheral edge of a hole formed in the guide pulley supporting member, into the groove.

### TECHNICAL FIELD

The present invention relates to a window regulator which moves a window pane of a vehicle up and down, and in particular relates to a guide pulley support structure thereof.

### BACKGROUND ART

Window regulators are generally provided with a slider base which is fixed to a window pane, a wire (drive wire) which is fixed to the slider base and extends upward and downward, wire guide members (guide pulleys) which are positioned in upper and lower areas in a door panel to guide the wire that extends upward and downward, and a driver which includes a drive mechanism for reeling out the wire, the direction of which is changed by the guide members, on one end thereof and reeling in the wire on the other end thereof. Slider bases are broadly classified into two types: a slider-guide type which is provided with a slider guide (panel member/guide rail) disposed in the door panel, and a guideless type which is not provided with such a slider guide. Slider-guide types are also classified into two types: a double guide type provided with a pair of slider guides, and a single guide type provided with only one slider guide. Additionally, although a rotatable guide pulley is usually used as each of the upper and lower wire guide members, sometimes one of the upper and lower wire guide members is made as a wire drum or a non-rotatable slider. The drive mechanism of the driver can either be electrically driven or manually driven.

In each of these types of window regulators, at least one rotatable guide pulley is an indispensable member and conventionally supported by fixing a holed shaft member, which is inserted into a rotational central hole of the guide pulley, to a metal pulley supporting member. The holed shaft member has a shaft hole in the shaft portion thereof, and a center shaft member which is inserted into this shaft hole and is lastly fixed to a door panel (a strengthening member therein) whereby the guide pulley is rotatably supported. A pulley bracket made as a separate member from the guide member of the slider base and is fixed to the inside of the door panel afterward, and a metal guide rail which guides the slider base are known in the art as pulley support members. The pulley bracket (guide pulley/shaft member), in one mode thereof, is fixed to a plastic panel member together with the driver to form a subassembly, and after this subassembly is inserted in the door panel, the subassembly is installed inside the door by making the central shaft member, which is inserted into the shaft hole of the holed shaft member, supported by the door panel.

### CITATION LIST

### Patent Literature

Patent Literature 1: WIPO Published Patent Application No. WO 2011/095414

Patent Literature 2: Japanese Unexamined Patent Publication H07-238915

### SUMMARY OF INVENTION

### Technical Problem

In the guide pulley support structure of this conventional window regulator, the guide pulley supporting member is ultimately fixed to (supported by) the window panel via the center shaft member which is inserted into the holed shaft member. Accordingly, before the guide pulley supporting member is fixed to the door panel, it is sufficient for the guide pulley supporting member and the holed shaft member to be temporarily fixed to each other, and hence, they were conventionally coupled with, e.g., serrations. However, a serration coupling has insufficient strength (weak against pulling-out forces, especially in the axial direction), so that there was a concern that the holed shaft member would come off the guide pulley supporting member before the guide pulley supporting member is installed in the door panel.

Additionally, in the guide pulley support structure of a conventional window regulator, in an assembling process thereof, there exists a former stage in which the guide pulley is made to be supported by the holed shaft member and the guide pulley supporting member to form a pulley unit, and a latter stage in which, after this pulley unit is mounted inside the door panel, the center shaft member is inserted into the shaft hole of the holed shaft member while the center shaft member is made to be supported by (fixed to) the door panel. However, such a conventional guide pulley supporting member plays no special role in either the former stage or the latter stage of the assembling process.

The present invention has been devised with awareness of the above described problems of the guide pulley support structure of the conventional window regulator, and an object of the present invention is to obtain a guide pulley support structure which can firmly couple the guide pulley supporting member and the holed shaft member in a state where a guide pulley is rotatably supported.

In addition, an object of the present invention is to obtain a support structure in which the guide pulley supporting member is useful in positioning itself in the former stage, in which the guide pulley is made to be supported by the holed shaft member and the guide pulley supporting member to form a pulley unit, and in the latter stage, in which the center shaft member is made to be supported by (fixed to) the door panel after the center shaft member is inserted into the holed shaft member of the pulley unit.

### Solution to Problem

The present invention has been devised based on the findings that, in order to fix the guide pulley supporting member and the holed shaft member to each other with high strength, a groove (s) is formed in an end surface of the holed shaft member to couple the holed shaft member and the guide pulley supporting member by inserting a connecting edge, which is formed by plastically deforming the inner peripheral edge of a bored hole made in the guide pulley supporting member, into the groove.

Accordingly, a guide pulley support structure of a window regulator according to the present invention includes a slider base which is fixed to a window pane; a drive wire which is fixed to the slider base; a guide pulley which guides the drive wire; and a driver which drives the drive wire, wherein the guide pulley is supported by fixing a holed shaft member, which is inserted into a shaft hole of the guide pulley, to a guide pulley supporting member. A groove is formed on an end surface of the holed shaft member. The holed shaft member and the guide pulley supporting member are coupled together by inserting a connecting edge, which is formed by plastically deforming an inner peripheral edge of a hole formed in the guide pulley supporting member, into the groove.

A piercing and swaging process can be used to couple together the holed shaft member and the guide pulley supporting member. The piercing and swaging process is commonly known as a pierce nut (self piercing and clinch nut) formation method. Although the holed shaft member is a nut having a female thread on the inner peripheral surface thereof in a desirable embodiment of the present invention, the holed shaft member does not necessarily have to be a nut in the present invention. Namely, the holed shaft member according to the present invention can be a holed shaft member, the shaft hole of which is a simple hole (loose hole/clearance hole) having no female thread therein. In the case of the holed shaft member being a nut, the center shaft member is a bolt which is screw-engaged with the female thread of the nut. The piercing and swaging process for the holed shaft member, which includes a nut, is a swaging method in which a groove(s) is formed on an end surface of the holed shaft member, and in which a hole which corresponds to the inner peripheral edge of this groove of the holed shaft member is bored in the guide pulley supporting member while the inner peripheral edge of the bored hole is plastically deformed into the groove.

The front shape of the groove of the holed shaft member has a degree of freedom; however, considering formability in the piercing and swaging process and coupling strength to the guide pulley supporting member, it is desirable that the groove be formed of an annular groove as viewed from front.

A through-hole, which is used for positioning the guide pulley supporting member during the piercing and swaging process, can be formed in the guide pulley supporting member. The through-hole of the guide pulley supporting member can also be used as a positioner when a pulley unit is fixed to a door panel or a subpanel that is fixed to the door panel.

According to an aspect of the present invention, the guide pulley supporting member can include a guide portion which guides the slider base, wherein the guide pulley supporting member is supported by a subpanel which simultaneously supports the driver, and the subpanel is fixed to a door panel via a center shaft member which is inserted into the shaft hole of the holed shaft member.

The holed shaft member includes a pierce nut including a female thread formed on an inner peripheral surface of the shaft hole of the pierce nut, and the center shaft member includes a bolt which is screw-engaged with the female thread of the pierce nut.

The subpanel can be a plastic panel.

In a method of supporting a guide pulley to a door panel according to an aspect of the present invention, in a window regulator assembling method which includes a former stage, in which a holed shaft member inserted into a shaft hole of a guide pulley to be rotatable relative to the shaft hole is fixed to the guide pulley supporting member to form a pulley unit, and a latter stage, in which this pulley unit is fixed to a door panel or a subpanel which is fixed to the door panel, the present invention is characterized by the guide pulley supporting member being provided with a positioner (positioning through-hole) which plays a role in positioning of the guide pulley supporting member in each of the former and latter stages.

### Advantageous Effects of Invention

According to the present invention, since a groove is formed on an end surface of the holed shaft member wherein the holed shaft member and the guide pulley supporting member are coupled together by inserting a connecting edge, which is formed by plastically deforming an inner peripheral edge of a hole formed in the guide pulley supporting member, into the groove, the coupling strength between the guide pulley supporting member and the holed shaft member can be drastically enhanced.

### BRIEF DESCRIPTION OF DRAWINGS

FIG. 1 is a front elevational view of an embodiment of a guide pulley support structure of a window regulator according to the present invention, showing an assembled state thereof in which the guide pulley support structure is fixed to a plastic panel (subpanel assembly);

FIG. 2 is a sectional view taken along the line II-II shown in FIG. 1;

FIG. 3 is a sectional view taken along the line III-III shown in FIG. 1, showing a state where the plastic panel (subpanel assembly) is joined to a door frame (inner panel);

FIG. 4 is an exploded perspective view of a guide pulley supporting member (bracket), a guide pulley and a holed shaft member that are shown in FIG. 1;

FIG. 5 is a perspective view of the guide pulley supporting member (bracket), the guide pulley and the holed shaft member in an assembled state;

FIG. 6 is a front elevational view of the guide pulley supporting member (bracket), the guide pulley and the holed shaft member in an assembled state;

FIG. 7 is a sectional view taken along the line VII-VII shown in FIG. 6, showing an example of a piercing and swaging process; and

FIGS. 8(A), (B), (C), (D), (E) and (F) are front elevational views showing examples of the shape of a groove(s) which is formed in an end surface of the holed shaft member that is used in the guide pulley support structure of the window regulator according to the present invention.

### DESCRIPTION OF EMBODIMENTS

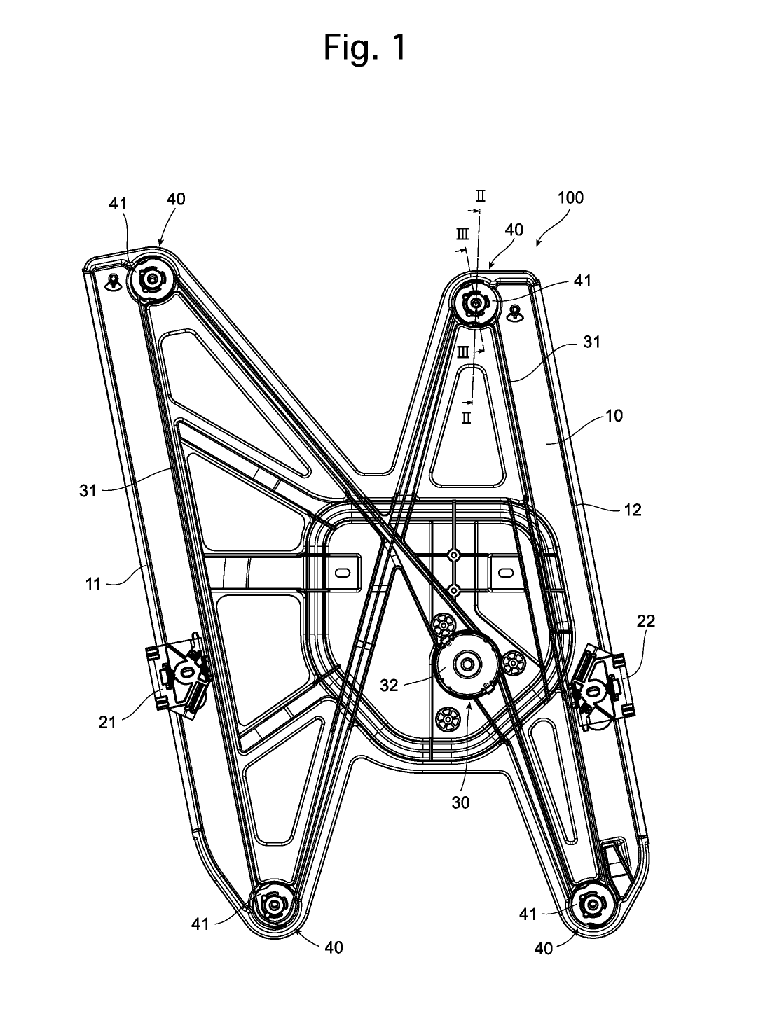

FIG. 1 is a subpanel assembly 100 of a wire-driven power window regulator to which the present invention has been applied. The subpanel assembly 100 supports a front and rear pair of slider bases 21 and 22, an electrical drive unit 30 and four pulley units 40 on a plastic subpanel (resin panel) 10. The slider bases 21 and 22 are slidably supported by guide rails 11 and 12 which are formed on the subpanel 10 to extend in the upward/downward direction, and a window pane (glass) (not shown) is fixed to the slider bases 21 and 22. A drive wire 31 which extends upward and downward from the slider bases 21 and 22 are led to the electrical drive unit 30 via a guide pulley 41 of each pulley unit 40 to be wound around a wire drum (driver) 32 which is rotatably supported by the electrical drive unit 30. The wire drum 32 is driven to rotate forward and reverse by a motor (driver), thereby moving the slider bases 21 and 22 (the window pane) up and down.

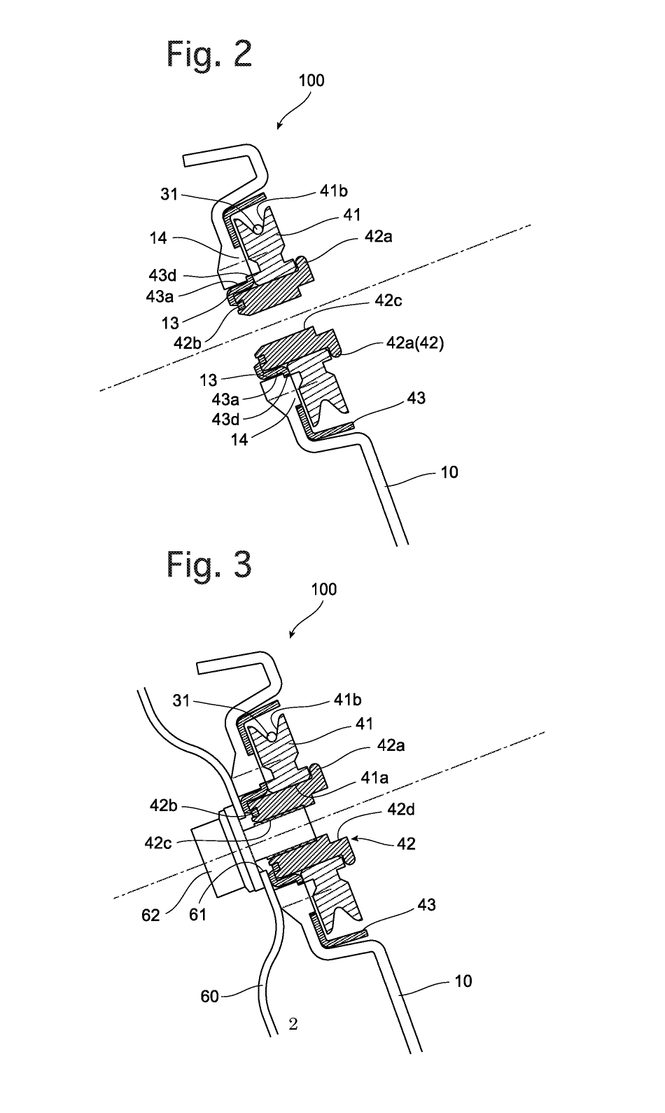

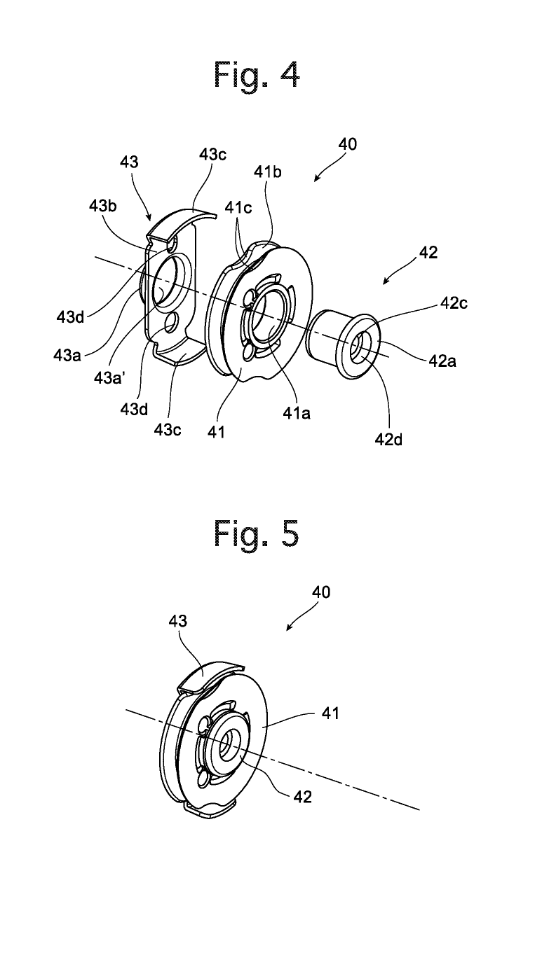

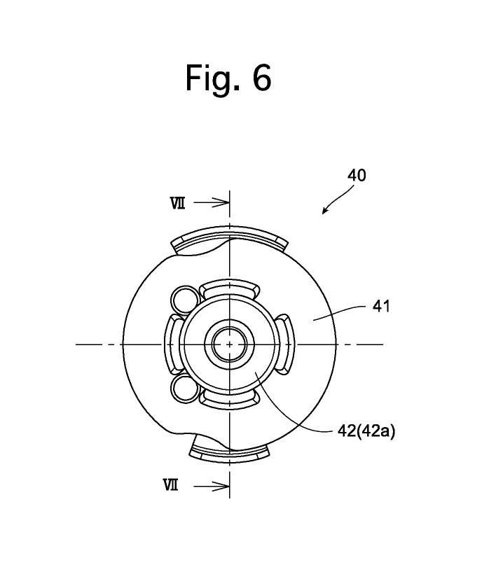

The detailed structure of each pulley unit 40 will be hereinafter discussed with reference to FIG. 2 onwards. The guide pulley 41 is an annular member made of resin which includes a shaft hole 41a and a peripheral annular groove 41b. Cutouts 41c (FIG. 4) which facilitate the insertion of the drive wire 31 into the annular groove 41b are formed on portions of annular walls that form the annular groove 41b. The guide pulley 41 is supported by a nut member (pierce nut/holed shaft member) 42 which is inserted into the shaft hole 41a and a pulley bracket (guide pulley supporting member) 43 to which an end of the nut member 42 is fixed.

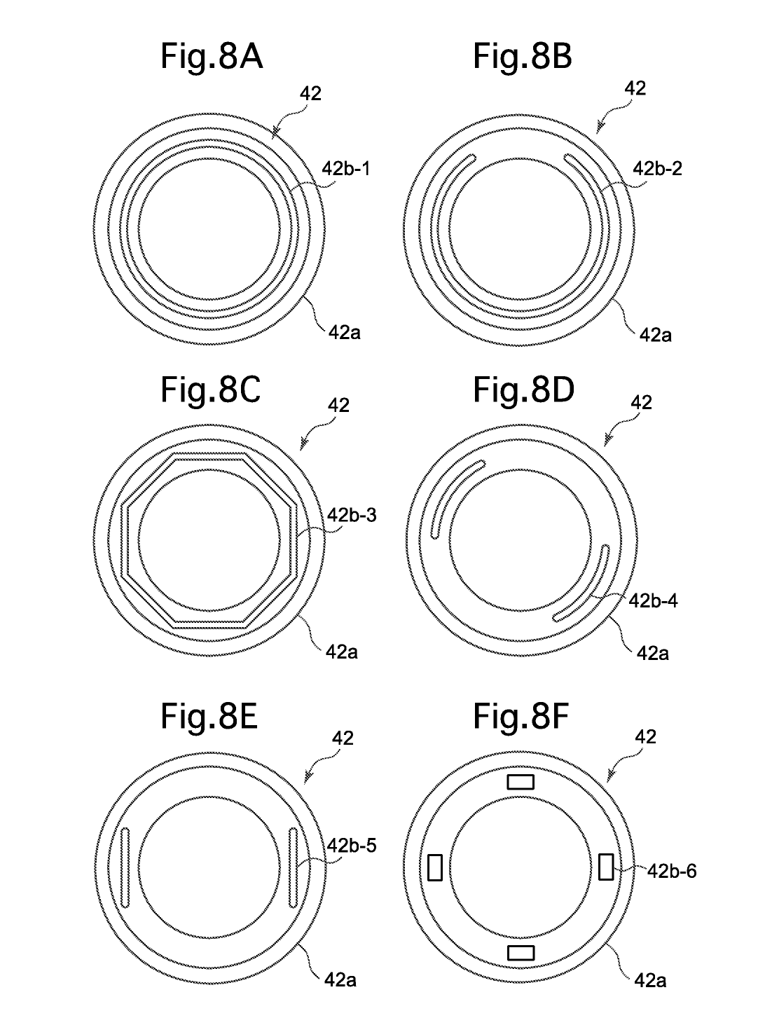

The nut member 42 is a metal shaft member which is provided with a flange portion 42a on one end surface thereof and with a groove 42b on the other surface thereof, and is provided with a female thread portion 42c in the shaft hole. FIGS. 8 (A) through (F) show examples of the front shape of the groove 42b; (A) shows an annular groove 42b-1, (B) shows a C-shaped groove (incomplete ring-shaped groove) 42b-2, (C) shows a polygonal (regular octagonal shaped) groove 42b-3, (D) shows a pair of circular arc grooves 42b-4, (E) shows a pair of linear grooves 42b-5 and (F) shows four segmentated grooves 42b-6. The cross section of the nut member 42 shown in FIGS. 2, 3 and 7 shows the shape of a cross section of a portion in which the groove 42b exists. In addition, a stepped portion 42d which is greater in diameter than the female thread portion 42c is formed at the end of the nut member 42 on the flange portion 42a side.

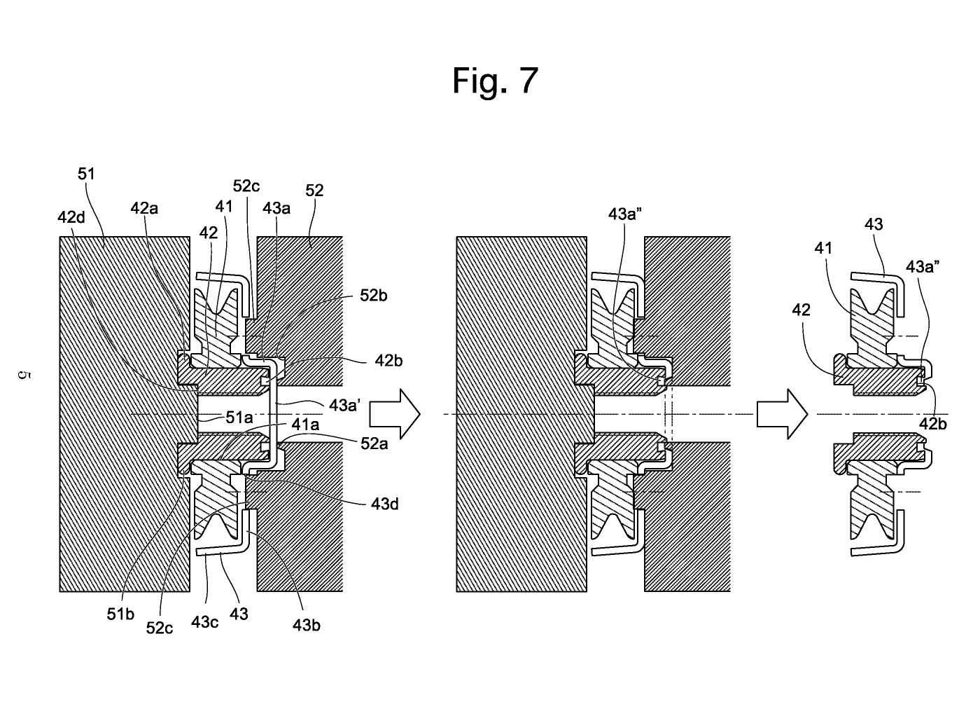

The pulley bracket 43 is coupled and fixed to the groove 42b of the nut member 42 by a piercing and swaging process and is provided with a cylindrical portion 43a. The cylindrical portion 43a is provided with a base wall 43a′ (FIGS. 4 and 7) which exists before the cylindrical portion 43a is coupled to the nut member 42. In addition, the pulley bracket 43 is provided with a pair of radial arms (planar portion) 43b which extend in radially opposite directions from the cylindrical portion 43a, and a pulley retaining wall 43c which is positioned outside the annular groove 41b is formed at the end of each radial arm 43b. A through-hole 43d, serving as a positioner, is formed in each of the pair of radial arms 43b.

The above-mentioned guide pulley 41, nut member 42 and pulley bracket 43 are coupled together by the piercing and swaging process shown in FIG. 7 to form a pulley unit 40. Namely, as shown at the left end in FIG. 7, the nut member 42 is inserted into the shaft hole 41a of the guide pulley 41, the flange portion 42a is made to contact (face against) an end surface of the guide pulley 41, and the groove 42b is made to contact (face against) the base wall 43a′ of the cylindrical portion 43a of the pulley bracket 43. The piercing and swaging process is for fixedly sandwiching and pressing the guide pulley 41, the nut member 42 and the pulley bracket 43 between upper and lower dies 51 and 52 (arranged in the leftward/rightward direction in FIG. 7), and the upper die 51 is provided with a cylindrical projecting portion 51a which is fitted into the stepped portion 42d and an annular groove 51b which receives the flange portion 42a. On the other hand, the lower die 52 is provided with an annular blade 52a which enters the groove 42b, an annular recess 52b which is formed around the annular blade 52a, and positioning projections 52c which enter through the through-holes 43d of the pair of pulley brackets 43. The positions of the lower die 52 and the pulley bracket 43 are defined by the fit-engagement relationship between the projections 52c and the through-holes 43d. In addition, moving the upper die 51 and the lower die 52 to approach closely to each other causes the annular blade 52a of the lower die 52 to enter the groove 42b; thereupon, a hole is formed at the central portion of the base wall 43a′ of the pulley bracket while plastically deforming an inner peripheral edge (connecting edge) 43a″ of the formed hole into the groove 42b. The groove 42b is in the shape of an undercut, the inner part of which is greater in sectional area than the entrance part, so that the nut member 42 and the pulley bracket 43 are firmly joined upon the inner peripheral edge 43a″ of the bored hole of the pulley bracket 43 entering the groove 42b while being plastically deformed.

Each pulley unit 40, which is unitized by performing the piercing and swaging process thereon as described above, is positioned relative to the subpanel 10 by fitting the cylindrical portion 43a of the pulley bracket 43 into a through-hole 13 which is formed in the subpanel 10 and fitting the through-hole 43d onto a positioning projection 14 which is formed on the subpanel 10 (FIG. 2).

The subpanel assembly 100, in which the slider bases 21 and 22, the electrical drive unit 30 and the pulley units 40 are mounted, is fixed within a door panel of a vehicle. FIG. 3 shows this fixing manner; fixing holes 61 are formed in a strengthening member (e.g., an inner panel) 60 to correspond to the positions and the number of the pulley units 40. The operation to fix the subassembly 100 within a door panel is completed by inserting a fixing bolt (center shaft member) 62 into each fixing hole 61 and screw-engaging the same with the female thread portion 42c of the associated nut member 42.

Although the above describes an embodiment in which the guide pulleys 41 are rotatably supported by the metal pulley brackets 43, an embodiment in which the guide pulleys 41 are supported by metal guide rails (guide pulley supporting members) is also possible according to the present invention. In such an embodiment, positioning through-holes which are formed in the guide rails can be used for the positioning of the guide rails in the piercing and swaging process and the positioning of the guide rails relative to a door panel when the guide rails are fixed to the door panel.

The front shape of the groove 42b of the nut member 42 has a degree of freedom, as illustrated by example in FIGS. 8(A) through 8(F); however, considering formability in the piercing and swaging process and coupling strength with the pulley bracket 43, the annular groove 42b-1 shown in FIG. 8(A) is most desirable.

### INDUSTRIAL APPLICABILITY

The present invention can be applied to a window regulator which moves a window pane of a vehicle up and down and can be used for vehicles in general which have such a window regulator.

### REFERENCE SIGN LIST

10 Subpanel (plastic panel)
11 12 Guide rail
21 22 Slider base
30 Electrical drive unit
31 Drive wire
32 Wire drum (driver)
40 Pulley unit
41 Guide pulley
41a Shaft hole
41b Annular groove
41c Cutout
42 Nut member (pierce nut/holed shaft member)
42a Flange portion
42b Groove
42c Female thread portion
42d Stepped portion
43 Pulley bracket (guide pulley supporting member)
43a Cylindrical portion
43a′ Base wall
43a″ Inner peripheral edge (connecting edge)
43b Radial arm
43c Pulley retaining wall
43d Through-hole
51 Upper die
52 Lower die
60 Strengthening member (inner panel/door panel)
61 Fixing hole
62 Fixing bolt (center shaft member)
100 Subpanel assembly

1. A guide pulley support structure of a window regulator comprising:
a slider base which is fixed to a window pane;
a drive wire which is fixed to said slider base;
a guide pulley which guides said drive wire; and
a driver which drives said drive wire, wherein said guide pulley is supported by fixing a holed shaft member, which is inserted into a shaft hole of said guide pulley, to a guide pulley supporting member,
wherein a groove is formed on an end surface of said holed shaft member, and
wherein said holed shaft member and said guide pulley supporting member are coupled together by inserting a connecting edge, which is formed by plastically deforming an inner peripheral edge of a hole formed in said guide pulley supporting member, into said groove.

2. The guide pulley support structure of said window regulator according to claim 1, wherein said groove of said holed shaft member is formed as an annular groove, in a front elevational view.

3. The guide pulley support structure of said window regulator according to claim 1, wherein a through-hole, which is used for positioning said guide pulley supporting member when said guide pulley supporting member and said holed shaft member are coupled together, is formed in said guide pulley supporting member.

4. The guide pulley support structure of said window regulator according to claim 3, wherein said through-hole of said guide pulley supporting member also serves as a positioner when said guide pulley supporting member is fixed to a door panel or a subpanel fixed to said door panel.

5. The guide pulley support structure of said window regulator according to claim 1, wherein said guide pulley supporting member comprises a guide portion which guides said slider base,
wherein said guide pulley supporting member is supported by a subpanel which simultaneously supports said driver, and
wherein said subpanel is fixed to a door panel via a center shaft member which is inserted into said shaft hole of said holed shaft member.

6. The guide pulley support structure of said window regulator according to claim 5, wherein said holed shaft member comprises a pierce nut including a female thread formed on an inner peripheral surface of said shaft hole of said pierce nut, and
wherein said center shaft member comprises a bolt which is screw-engaged with said female thread of said pierce nut.

7. The guide pulley support structure of said window regulator according to claim 5, wherein said subpanel comprises a plastic panel.
